(19) United States
(12) Patent Application Publication
(10) Pub. No.: US 2026/0099005 A1
(43) Pub. Date: Apr. 9, 2026

(54) STRIPPING APPARATUS FOR COATING LAYER OF OPTICAL FIBER

(71) Applicant: WuHan Raycus Fiber Laser Technologies CO., LTD, Wuhan, Hubei (CN)

(72) Inventors: Shuqiao LIU, Wuhan, Hubei (CN); Wulue YI, Wuhan, Hubei (CN); Mengze ZHU, Wuhan, Hubei (CN); Dapeng YAN, Wuhan, Hubei (CN)

(73) Assignee: WuHan Raycus Fiber Laser Technologies CO., LTD, Wuhan, Hubei (CN)

(21) Appl. No.: 18/881,701

(22) PCT Filed: Apr. 29, 2024
(86) PCT No.: PCT/CN2024/090633

§ 371 Date: Dec. 8, 2025

(30) Foreign Application Priority Data
Jun. 20, 2023 (CN) 202310727817.8

(51) Int. Cl. G02B 6/245

(52) U.S. Cl. CPC G02B 6/245

(57) ABSTRACT

The present disclosure provides a stripping apparatus for a coating layer of an optical fiber, including an optical fiber fixing device, a stripping device, and a cleaning device. The optical fiber fixing device is configured to fix an optical fiber and drive the optical fiber to rotate around a rotation axis and move along an extension direction of the rotation axis. The stripping device is provided on one side of the optical fiber fixing device along the extension direction of the rotation axis. The stripping device is configured to strip off a coating layer of the optical fiber. The cleaning device includes a cleaning space for cleaning the optical fiber, and the cleaning space is located between the stripping device and the optical fiber fixing device.

This application claims priority to Chinese Patent Application No. 202310727817.8, filed to the China Patent Office on Jun. 20, 2023. The entire content of the above application is incorporated into this application by reference.

### TECHNICAL FIELD

The present disclosure relates to the technical field of optical fiber manufacturing, and in particular, to a stripping apparatus for a coating layer of an optical fiber.

### BACKGROUND

During a manufacturing process of an optical fiber, it is generally necessary to strip off a part of a coating layer on a surface of the optical fiber, then clean the surface of the optical fiber from which the part of the coating layer has been stripped, and finally manufacture a stripper on the surface of the optical fiber from which the coating layer has been stripped. In prior arts, manual methods are generally used to strip off the coating layer on the surface of the optical fiber and clean the surface of the optical fiber, which is inefficient.

### SUMMARY

Embodiments of the present disclosure provide a stripping apparatus for a coating layer of an optical fiber, aiming to solve the problem of low efficiency in stripping off the coating layer on the surface of the optical fiber and cleaning the surface of the optical fiber surface in prior arts.

Embodiments of the present disclosure provides a stripping apparatus for a coating layer of an optical fiber, including:
an optical fiber fixing device configured to fix an optical fiber and drive the optical fiber to rotate around a rotation axis and move along an extension direction of the rotation axis;
a stripping device provided on one side of the optical fiber fixing device along the extension direction of the rotation axis and configured to strip a coating layer of the optical fiber; and
a cleaning device including a cleaning space for cleaning the optical fiber, wherein the cleaning space is located between the stripping device and the optical fiber fixing device.

In some embodiments, the optical fiber fixing device includes a clamping mechanism and a moving mechanism, the clamping mechanism includes a first clamping member, a second clamping member, and a first driving member, the first clamping member includes a first clamping surface, the first clamping surface is provided with a guiding groove extending along the rotation axis, the second clamping member includes a second clamping surface, the first driving member is disposed on the first clamping member, and the first driving member is connected to the second clamping member and configured to drive the second clamping surface close to or away from the first clamping surface;
the moving mechanism is connected to the first clamping member and configured to drive the first clamping member to rotate around the rotation axis and move along the extension direction of the rotation axis.

In some embodiments, an inner surface of the guiding groove is provided with one or more through holes configured to communicate with a suction component.

In some embodiments, a plurality of through holes are provided on the inner surface of the guiding groove, and the plurality of through holes are sequentially distributed along a length direction of the guiding groove.

In some embodiments, the optical fiber fixing device further includes a pressure sensor, and the pressure sensor is configured to detect an air pressure in the through hole.

In some embodiments, the optical fiber fixing device further includes a limiting mechanism, the limiting mechanism is connected to the first clamping member, and the limiting mechanism is configured to limit coils of the optical fiber to the first clamping member.

In some embodiments, the limiting mechanism includes a limiting rod and a second driving member, the first clamping member includes a limiting surface, the second driving member is provided on the first clamping member, and the second driving member is connected to the limiting rod and drives one end of the limiting rod close to or away from the limiting surface to make the one end of the limiting rod to abut against or separate from the limiting surface.

In some embodiments, a limiting groove is provided on the first clamping member, the limiting surface of the first clamping member is located in the limiting groove, the first clamping member further includes an inner side surface located in the limiting groove and opposite to the limiting surface, a distribution direction of the inner side surface and the limiting surface forms an angle with the extension direction of the rotation axis;

a mounting hole is provided on the inner side surface of the limiting groove, the limiting rod is slidably installed in the mounting hole, and one end of the limiting rod is arranged opposite to the limiting surface.

In some embodiments, the mounting hole extends to one side of the first clamping member along a direction from the limiting surface to the inner side surface; the second driving member is provided on the side of the first clamping member along the direction from the limiting surface to the inner side surface; and the second driving member is connected to another end of the limiting rod to drive the limiting rod to slide in the mounting hole along the distribution direction of the inner side surface and the limiting surface.

In some embodiments, the second clamping member includes an elastic pad, and the second clamping surface is formed on the elastic pad.

In some embodiments, the first clamping member includes a first magnetic part, the second clamping member includes a second magnetic part, and the first magnetic part is configured to be magnetically attracted to the second magnetic part.

In some embodiments, the first clamping surface is provided with a recess, and the first magnetic part is installed in the recess.

In some embodiments, the stripping device includes a mounting mechanism, a cutting mechanism, and a heating component, the mounting mechanism includes a supporting seat and a mounting cover, the mounting cover is slidably connected with the supporting seat and has a clamping position and a releasing position; the supporting seat and/or the mounting cover are provided with the heating component, and the heating component is configured to heat the optical fiber; the cutting mechanism includes a first blade provided on the supporting seat and a second blade provided on the mounting cover;
the mounting cover is arranged opposite to the supporting seat when in the clamping position and the releasing position, respectively; when the mounting cover is in the clamping position, a cutting port is formed between the first blade and the second blade for cutting the coating layer of the optical fiber; and a distance between the first blade and the second blade when the mounting cover is in the releasing position is greater than a distance between the first blade and the second blade when the mounting cover is in the clamping position.

In some embodiments, the mounting mechanism includes a sliding seat slidably connected to the supporting seat, and the mounting cover is provided on the sliding seat so that the mounting cover is slidably connected to the supporting seat;
the mounting mechanism further includes an elastic member, one end of the elastic member is connected to the supporting seat, and another end of the elastic member is connected to the sliding seat to exert an elastic force on the sliding seat, so that the sliding seat drives the mounting cover to slide in a direction from the clamping position to the releasing position.

In some embodiments, the stripping apparatus for the coating layer of the optical fiber further includes a pushing mechanism, and the pushing mechanism is configured to abut against the mounting cover and push the mounting cover to slide along a direction from the releasing position to the clamping position.

In some embodiments, the mounting cover is rotationally connected to the sliding seat, the mounting cover is configured to rotate relative to the sliding seat between an open position and the releasing position, and a distance between the first blade and the second blade when the mounting cover is in the open position is greater than a distance between the first blade and the second blade when the mounting cover is in the releasing position; the sliding seat includes a limiting part, and when the mounting cover is in the releasing position, the limiting part is located below the mounting cover and abuts against the mounting cover;
the stripping device further includes a driving structure provided on the supporting seat, and the driving structure is connected to the mounting cover to drive the mounting cover to rotate between the open position and the releasing position.

In some embodiments, the cleaning device includes a clamping assembly and two supply assemblies, each of the supply assemblies includes a first driving mechanism and a supply mechanism for supplying a cleaning belt, the two supply mechanisms are arranged opposite to each other along a first direction, the cleaning space is formed between the two supply mechanisms, a part of the cleaning belt supplied by the supply mechanism is located on one side of the supply mechanism facing the cleaning space; the first driving mechanism is connected to the supply mechanism to drive the supply mechanism to move in the first direction; and the first direction forms an angle with the extension direction of the rotation axis;
the clamping assembly is configured to clamp the cleaning belts located on the sides of the two supply mechanisms facing cleaning space.

In some embodiments, the supply mechanism includes a supporting structure, two mounting shafts rotatably installed on the supporting structure, a second driving mechanism, and an abutting structure, one of the mounting shafts is configured to install a first reel wound with the cleaning belt, and another one of the mounting shafts is configured to install a second reel, and the second reel is configured to connect with one end of the cleaning belt; the second driving mechanism is connected to at least one of the two mounting shafts and drives the corresponding one of the mounting shafts to rotate, so that the first reel releases the cleaning belt and the second reel winds the cleaning belt;
the abutting structure includes two abutting rods arranged side by side and at intervals on the supporting structure, the cleaning space is formed between the two abutting rods of each of the two supply mechanisms, and sides of the two abutting rods close to the cleaning space are configured to respectively abut against the cleaning belt between the first reel and the second reel; and the clamping assembly is configured to clamp the cleaning belts between the two abutting rods of each of the two supply mechanisms.

In some embodiments, the clamping assembly includes a bracket and a clamping structure, the clamping structure includes two clamping components and a driving component connected to the bracket, the driving component is connected to the two clamping components to drive the two clamping components toward or away from each other;
a clamping space for clamping the cleaning belt is formed between the two clamping components, at least one of the clamping components is provided with a channel, the channel is configured to communicate with cleaning agent supply assembly, and the channel is provided with a cleaning agent supply port on one side of a corresponding one of the clamping components facing the clamping space.

In some embodiments, the cleaning agent supply assembly includes a liquid supply pump and a connecting pipeline, and the liquid supply pump is communicated with the channel through the connecting pipeline to supply the cleaning agent to the channel.

The stripping apparatus for the coating layer of the optical fiber provided by the embodiments of the present disclosure fixes the optical fiber and drives the optical fiber to rotate around the rotation axis and move along the extension direction of the rotation axis through the optical fiber fixing device, the stripping device for stripping the coating layer of the optical fiber is arranged on one side of the optical fiber fixing device along the extension direction of the rotation axis, and the cleaning space of the cleaning device for cleaning the optical fiber is located between the stripping device and the optical fiber fixing device. When the optical fiber fixing device fixes the optical fiber and then drives the optical fiber to move along the extension direction of the rotation axis, the optical fiber can be driven to move along the extension direction of the rotation axis relative to the stripping device, so as to strip off part of the coating layer of the optical fiber.

Moreover, when the optical fiber fixing device drives the optical fiber to move along the extension direction of the rotation axis, the optical fiber also passes through the cleaning space and moves relative to the cleaning device along the extension direction of the rotation axis, so that the surface of the optical fiber is cleaned by the cleaning device to remove debris remaining after a part of the coating layer of the optical fiber has been stripped off.

In addition, the optical fiber fixing device can also drive the optical fiber to rotate around the rotation axis to adjust an area of the surface of the optical fiber contacting the cleaning device. Thus, the cleaning device can clean relatively large area of the surface of the optical fiber to improve the cleaning effect of the optical fiber.

Therefore, in the stripping apparatus for the coating layer of the optical fiber provided by the embodiments of the present disclosure, the stripping work of the coating layer of the optical fiber can be completed through cooperation between the optical fiber fixing device and the stripping device, and the cleaning work of the optical fiber can be completed through the cooperation between the optical fiber fixing device and the cleaning device. The operations are simple and convenient, and can effectively improve the efficiency of stripping off the coating layer and cleaning of the optical fiber.

### DESCRIPTION OF DRAWINGS

The technical solutions and other beneficial effects of the present disclosure will be apparent through a detailed description of the specific embodiments of the present disclosure in conjunction with the accompanying drawings.

FIG. 1 is a schematic structural diagram of an embodiment of a stripping apparatus for a coating layer of an optical fiber provided by embodiments of the present disclosure;

FIG. 2 is a schematic structural diagram of an embodiment of an optical fiber fixing device provided by embodiments of the present disclosure;

FIG. 3 is a schematic diagram of an assembly structure of a first clamping member, a second clamping member, a positioning mechanism, and a limiting structure provided by embodiments of the present disclosure;

FIG. 4 is a cross-sectional view of an embodiment of a positioning member and a connector provided by embodiments of the present disclosure, which are sectioned along a length direction of a rotation axis;

FIG. 5 is a schematic structural diagram of an embodiment of a clamping assembly provided by embodiments of the present disclosure;

FIG. 6 is a schematic structural diagram of an embodiment of a clamping structure provided by embodiments of the present disclosure;

FIG. 7 is a schematic structural diagram of an embodiment of two supply assemblies provided by embodiments of the present disclosure;

FIG. 8 is a schematic structural diagram of an embodiment of a stripping device provided by embodiments of the present disclosure;

FIG. 9 is an enlarged view of section A in FIG. 8;

FIG. 10 is a schematic diagram of an assembly structure of a mounting mechanism, a cutting mechanism, and a heating component provided by embodiments of the present disclosure; and

FIG. 11 is a schematic exploded view of a mounting mechanism provided by embodiments of the present disclosure.

Stripping apparatus for coating layer of optical fiber 1; optical fiber fixing device 10; clamping mechanism 11; first clamping member 111; mounting groove 1110; connecting hole 1111; limiting groove 1112; limiting surface 1113; inner side surface 1114; mounting hole 1115; positioning member 112; first clamping surface 1120; guiding groove 1121; through hole 1122; cavity 1123; opening 1124; connecting port 1125; recess 1126; connector 113; sealing member 114; first magnetic part 115; second clamping member 116; second magnetic part 1161; elastic pad 117; second clamping surface 1171; first driving member 118; pressure sensor 12; limiting mechanism 13; limiting rod 131; second driving member 132; moving mechanism 14; moving seat 141; third driving member 142; rack 143; gear 144; mounting seat 145; fourth driving member 146; stripping device 20; mounting mechanism 21; supporting seat 211; first abutting part 2111; rail 212; slider 213; mounting cover 214; sliding seat 215; second abutting part 2151; limiting part 2152; positioning hole 2153; elastic member 216; cutting mechanism 22; cutting port 220; first blade 221; second blade 222; heating component 23; driving structure 24; pushing mechanism 25; cleaning device 30; cleaning space 301; supply assembly 31; first driving mechanism 311; supply mechanism 312; supporting structure 3121; mounting shaft 3122; second driving mechanism 3123; abutting structure 3124; abutting rod 3125; clamping assembly 32; bracket 321; clamping structure 322; clamping component 3221; channel 3222; clamping space 3223; driving component 3224; cleaning agent supply assembly 33; optical fiber 40; first reel 51; second reel 52; cleaning belt 53; and rotation axis X.

### EMBODIMENTS OF THE INVENTION

The technical solutions in the embodiments of the present disclosure will be clearly and completely described below with reference to the accompanying drawings in the embodiments of the present disclosure. It is appreciated that the described embodiments are only some of the embodiments of the present disclosure, but not all of the embodiments. Based on the embodiments in the present disclosure, all other embodiments obtained by those skilled in the art without creative efforts shall fall within the scope of protection of the present disclosure.

In the description of the present disclosure, it needs to be understood that orientations or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are based on the orientations or positional relationships shown in the drawings, which are only for the convenience of describing the present disclosure and simplifying the description, and do not indicate or imply that the device or element referred to must have a specific orientation, be constructed and operated in a specific orientation. Therefore, it cannot be construed as a limitation on this application. In addition, the terms “first” and “second” are used for descriptive purposes only and cannot be understood as indicating or implying relative importance or implicitly indicating the quantity of indicated technical features. Thus, features defined as “first” and “second” may explicitly or implicitly include one or more of the described features. In the description of the present disclosure, “plurality” means two or more than two, unless otherwise explicitly and specifically limited.

In the description of the present disclosure, it should be noted that, unless otherwise clearly stated and limited, the terms “installation” and “connection” should be understood in a broad sense. For example, it may be fixed connection, detachable connection, or integral connection; it may be mechanical connection, electrical connection, or mutual communication; it may be direct connection or indirect connection through an intermediary; and it may be internal connection of two elements or the interaction between two elements. For those of ordinary skill in the art, the specific meanings of the above terms in the present disclosure can be understood according to specific circumstances.

In the present disclosure, unless otherwise expressly stated and limited, a first feature “above” or “below” a second feature may include direct contact between the first and second features, or may include contact between the first and second features not directly but through additional features between them. Furthermore, the first feature “on”, “above”, or “over” the second feature include the first feature being directly above and diagonally above the second feature, or simply mean that the first feature is higher in level than the second feature. The first feature “under” or “below” the second feature includes the first feature being directly below and diagonally below the second feature, or simply means that the first feature is lower in level in level than the second feature.

The following disclosure provides many different embodiments or examples for implementing the various structures of the present disclosure. To simplify the disclosure of the present disclosure, the components and arrangements of specific examples are described below. Of course, they are merely examples and are not intended to limit the application. Furthermore, the present disclosure may repeat reference numbers and/or reference letters in different examples, such repetition is provided for the purposes of simplicity and clarity, but not for by itself indicating a relationship between the various embodiments and/or arrangements discussed. In addition, the present disclosure provides examples of various specific processes and materials, but one of ordinary skill in the art will recognize the implementation of other processes and/or the use of other materials.

Embodiments of the present disclosure provide stripping apparatuses for coating layer of optical fiber. Each is explained in detail below.

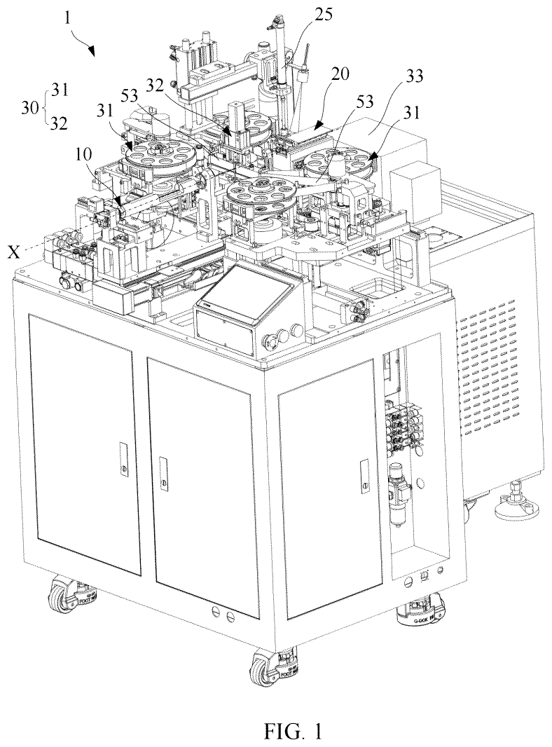

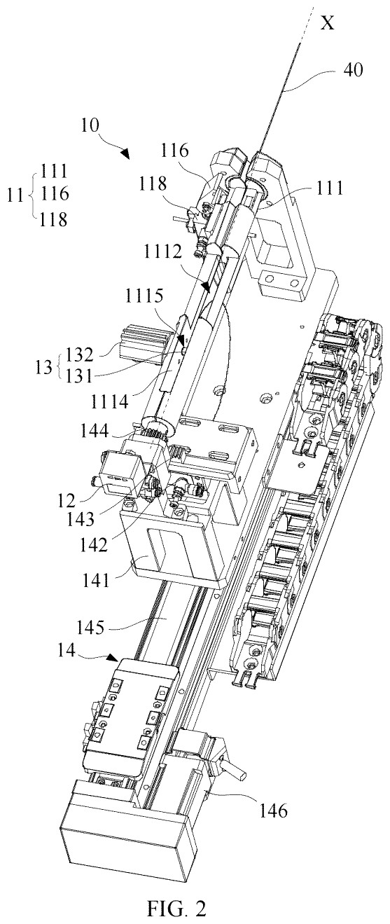

FIG. 1 is a schematic structural diagram of an embodiment of a stripping apparatus for a coating layer of an optical fiber provided by embodiments of the present disclosure. As illustrated in FIG. 1, the stripping apparatus for the coating layer of the optical fiber 1 includes an optical fiber fixing device 10, a stripping device 20, and a cleaning device 30. The optical fiber fixing device 10 is configured to fix an optical fiber 40 (referring to FIG. 2) and drive the optical fiber 40 to move. The stripping device 20 is configured to strip off a coating layer of the optical fiber 40, and the cleaning device 30 is configured to clean a surface of the optical fiber 40.

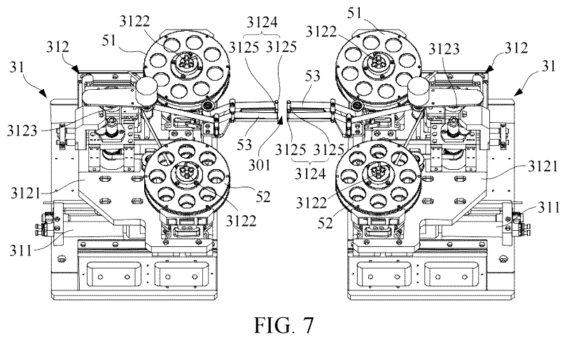

As illustrated in FIG. 1 to FIG. 4, the optical fiber fixing device 10 is configured to fix the optical fiber 40 and drive the optical fiber 40 to rotate around a rotation axis X and move along an extension direction of the rotation axis X. The stripping device 20 is provided on one side of the optical fiber fixing device 10 along the extension direction of the rotation axis X. The stripping device 20 is configured to strip off the coating layer of the optical fiber 40. The cleaning device 30 includes a cleaning space 301 (referring to FIG. 7) for cleaning the optical fiber 40. When the optical fiber 40 passes through the cleaning space 301, the cleaning device 30 can clean the optical fiber 40. The cleaning space 301 is located between the stripping device 20 and the optical fiber fixing device 10.

When the optical fiber fixing device 10 fixes the optical fiber 40 and then drives the optical fiber 40 to move along the extension direction of the rotation axis X, the optical fiber fixing device 10 can drive the optical fiber 40 to move along the extension direction of the rotation axis X relative to the stripping device 20, so as to strip off a part of the coating layer of the optical fiber 40.

Moreover, when the optical fiber fixing device 10 drives the optical fiber 40 to move along the extension direction of the rotation axis X, the optical fiber 40 also passes through the cleaning space 301 and moves relative to the cleaning device 30 along the extension direction of the rotation axis X, so that the surface of the optical fiber 40 is cleaned by the cleaning device 30 to remove debris remaining after the part of the coating layer of the optical fiber 40 has been stripped off.

In addition, the optical fiber fixing device 10 can also drive the optical fiber 40 to rotate around the rotation axis X to adjust an area of the surface of the optical fiber 40 contacting the cleaning device 30. Thus, the cleaning device 30 can clean more a relatively large area of the surface of the optical fiber 40 to improve the cleaning effect of the optical fiber 40.

Therefore, in the stripping apparatus for the coating layer of the optical fiber 1 provided by the embodiments of the present disclosure, the stripping work of the coating layer of the optical fiber 40 can be completed through cooperation between the optical fiber fixing device 10 and the stripping device 20, and the cleaning work of the optical fiber 40 can be completed through the cooperation between the optical fiber fixing device 10 and the cleaning device 30. The operations thereof are simple and convenient, and can effectively improve efficiency of stripping off the coating layer and cleaning of the optical fiber 40.

In some embodiments, as illustrated in FIG. 2 to FIG. 4, the optical fiber fixing device 10 includes a clamping mechanism 11 and a moving mechanism 14. The clamping mechanism 11 is configured to clamp and fix the optical fiber 40. The moving mechanism 14 is connected to the clamping mechanism 11. The moving mechanism 14 is configured to drive the clamping mechanism 11 to rotate around the rotation axis X and move along the rotation axis X, so as to drive the optical fiber 40 to rotate around the rotation axis X and move along the rotation axis X.

The clamping mechanism 11 includes a first clamping member 111, a second clamping member 116, and a first driving member 118. The first clamping member 111 includes a first clamping surface 1120, and the first clamping surface 1120 is provided with a guiding groove 1121 extending along the rotation axis X. The second clamping member 116 includes a second clamping surface 1171. The first driving member 118 is disposed on the first clamping member 111, and the first driving member 118 is connected to the second clamping member 116 and configured to drive the second clamping surface 1171 close to or away from the first clamping surface 1120. After a part of the optical fiber 40 is placed in the guiding groove 1121 along a length direction of the guiding groove 1121, the second clamping member 116 is driven by the first driving member 118 to rotate relative to the first clamping member 111, so that the second clamping surface 1171 is brought close to the first clamping surface 1120, the second clamping surface 1171 abuts against one side of the optical fiber 40 away from the first clamping surface 1120, and the first clamping member 111 and the second clamping member 116 clamp and fix the optical fiber 40, thereby the optical fiber 40 can rotate and move together with the first clamping member 111 and the second clamping member 116.

The moving mechanism 14 is connected to the first clamping member 111 and is configured to drive the first clamping member 111 to rotate around the rotation axis X and move along the extension direction of the rotation axis X. Therefore, the moving mechanism 14 can drive the entire clamping mechanism 11 and optical fiber 40 to rotate together around the rotation axis X and move along the extension direction of the rotation axis X through driving the first clamping member 111 to rotate around the rotation axis X and move along the extension direction of the rotation axis X.

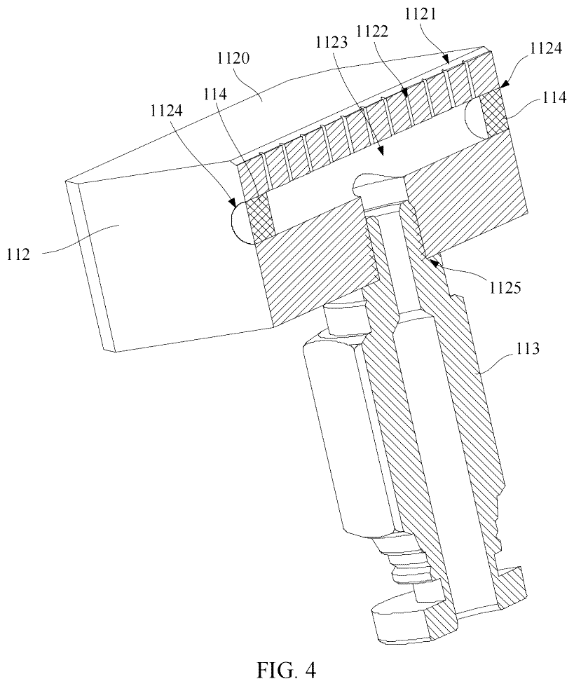

In some embodiments, as illustrated in FIG. 4, an inner surface of the guiding groove 1121 is provided with one or more through holes 1122 configured to communicate with a suction component (not shown in the figures). Therefore, after a part of the optical fiber 40 is placed in the guiding groove 1121, the through hole 1122 can be exerted an suction through the suction component, so that the through hole 1122 can adsorb the optical fiber 40 to the inner surface of the guiding groove 1121, thereby positioning the optical fiber 40 in the guiding groove 1121 to prevent the optical fiber 40 from protruding from the guiding groove 1121 when the second clamping surface 1171 of the second clamping member 116 is brought close to the first clamping surface 1120 of the first clamping member 111.

The stripping apparatus for the coating layer of the optical fiber 1 further includes the suction component (not shown in the figures), and the suction component is connected to the through hole 1122. Of course, the suction component may also be a component outside the stripping apparatus for the coating layer of the optical fiber 1. The suction component is configured to suck the air in the through hole 1122. The suction component may be a vacuum pump, a fan, etc., and is not limited here.

Continuing to refer to FIG. 4, there are a plurality of through holes 1122, and the plurality of through holes 1122 are sequentially distributed along the length direction of the guiding groove 1121. Therefore, multiple positions in the length direction of the optical fiber 40 can be adsorbed through the through holes 1122 to further improve the absorbing and positioning effect of the optical fiber 40.

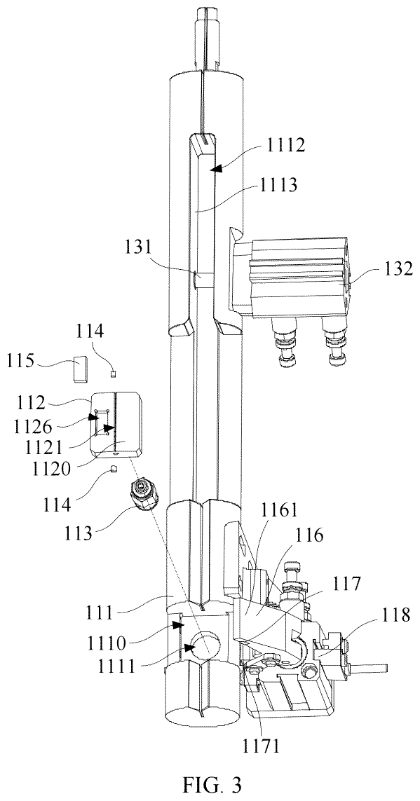

In some embodiments, as illustrated in FIG. 3 and FIG. 4, the first clamping member 111 is detachably connected to a positioning member 112, and the first clamping surface 1120 is formed on the positioning member 112, the guiding groove 1121 is provided on the positioning member 112, and the through hole 1122 is located on the positioning member 112. It can be understood that by detachably connecting the positioning member 112 with the first clamping member 111 and providing the guiding groove 1121 and the through hole 1122 on the positioning member 112, the guiding groove 1121 and the through hole 1122 can be processed on the positioning member 112 first, and then the positioning member 112 is connected with the first clamping member 111, thereby making the processing of the guiding groove 1121 and the through hole 1122 more convenient.

The first clamping member 111 is provided with a mounting groove 1110, and the positioning member 112 is detachably installed in the mounting groove 1110, so that the positioning member 112 and the first clamping member 111 are detachably connected. Of course, the positioning member 112 and the first clamping member 111 may also be detachably connected through screw connection, snap connection, or other means.

In some embodiments, as illustrated in FIG. 4, the positioning member 112 is provided with a connecting port 1125 that communicates with the through hole 1122. The connecting port 1125 is configured to communicate with the suction component, so that the through hole 1122 communicates with the suction component. The first clamping member 111 is provided with a connecting hole 1111 passing through it. The connecting hole 1111 corresponds to a position of the connecting port 1125 of the positioning member 112, so that when the connecting port 1125 is connected to the suction component, there will be no interference from the first clamping member 111.

The connecting hole 1111 penetrating the first clamping member 111 is provided at a bottom of the mounting groove 1110, and the connecting port 1125 communicating with the through hole 1122 is provided on one side of the positioning member 112 away from the guiding groove 1121. The connecting port 1125 corresponds to the position of the connecting hole 1111 and is configured to communicate with the suction component. By providing the connecting port 1125 at the bottom of the mounting groove 1110 of the first clamping member 111 and providing the connecting port 1125 communicating with the through hole 1122 on the side of the positioning member 112 away from the guiding groove 1121, the connecting port 1125 corresponds to the position of the connecting hole 1111, and the connecting port 1125 can be easily connected to the suction component without being interfered by the first clamping member 111.

In some embodiments, as illustrated in FIG. 3 and FIG. 4, a connector 113 is connected to the positioning member 112. One end of the connector 113 is communicated with the connecting port 1125, and another end of the connector 113 is configured to communicate with the suction component, so as to connect the connecting port 1125 with the suction component.

The connector 113 passes through the connecting hole 1111. Therefore, the connecting hole 1111 can avoid the connector 113 and facilitate communication between the connector 113 and the suction component. Specifically, the connector 113 is connected to the side of the positioning member 112 away from the guiding groove 1121. The connector 113 passes through the connecting hole 1111. One end of the connector 113 is communicated with the connecting port 1125, and another end of the connector 113 is configured to communicate with the suction port.

In some embodiments, the positioning member 112 is provided with a cavity 1123 extending along the length direction of the guiding groove 1121. One end of the through hole 1122 is communicated with the guiding groove 1121, and another end of the through hole 1122 is communicated with the cavity 1123. The connecting port 1125 is communicated with the cavity 1123. Therefore, the connecting port 1125 communicates with the through hole 1122 through the cavity 1123. Especially when a plurality of through holes 1122 are provided, another ends of the plurality of through holes 1122 are respectively communicated with the cavity 1123, so that the connecting port 1125 and the plurality of through holes 1122 can be communicated simultaneously through the cavity 1123.

The cavity 1123 in the positioning member 112 has an opening 1124 formed on one side of the positioning member 112 along the extension direction of the rotation axis X. Therefore, the cavity 1123 may be easily formed in the positioning member 112 using a drilling tool. A sealing member 114 is provided at the opening 1124 to seal the opening 1124 to prevent external air from entering the cavity 1123 through the opening 1124 and affecting the absorbing and positioning effect of the through hole 1122 on the optical fiber 40.

The cavity 1123 may be formed with openings 1124 on both sides of the positioning member 112 along the extension direction of the rotation axis X, or the cavity 1123 may be formed with the opening 1124 only on one side of the positioning member 112 along the extension direction of the rotation axis X. Of course, in the case of the former, sealing members 114 may be provided at each opening 1124 respectively.

In some embodiments, the optical fiber fixing device 10 further includes a pressure sensor 12, and the pressure sensor 12 is configured to detect an air pressure in the through hole 1122, so that the operator can determine an adsorption force of the through hole 1122 on the optical fiber 40 based on the air pressure detected by the pressure sensor 12. The pressure sensor 12 communicates with the through hole 1122, the cavity 1123, and the connecting port 1125 through a pipeline, thereby facilitating detecting the air pressure in the through hole 1122. The pressure sensor 12 can display the air pressure in the through hole 1122, so that the operator can identify a state of the air pressure in the through hole 1122 through the pressure sensor 12.

In some embodiments, as illustrated in FIG. 2 and FIG. 3, the optical fiber fixing device 10 further includes a limiting mechanism 13. The limiting mechanism 13 is connected to the first clamping member 111. The limiting mechanism 13 is configured to limit coils of the optical fiber 40 to the first clamping member 111. Therefore, the coils of the optical fiber 40 can be limited by the limiting mechanism 13 to prevent the coils of the optical fiber 40 from being wound around the stripping apparatus for the coating layer of the optical fiber 1.

The limiting mechanism 13 includes a limiting rod 131 and a second driving member 132. The first clamping member 111 includes a limiting surface 1113. The second driving member 132 is provided on the first clamping member 111. The second driving member 132 is connected to the limiting rod 131 and drives one end of the limiting rod 131 close to or away from the limiting surface 1113, thereby making one end of the limiting rod 131 to abut against or separate from the limiting surface 1113. Therefore, the second driving member 132 can drive the limiting rod 131 to move toward the limiting surface 1113, so that the limiting rod 131 passes through the coils of the optical fiber 40 and then abuts against the limiting surface 1113 of the first clamping member 111, so as to limit the coils of the optical fiber 40 on the first clamping member 111.

A limiting groove 1112 is provided on the first clamping member 111. The limiting surface 1113 of the first clamping member 111 is located in the limiting groove 1112. The first clamping member 111 further includes an inner side surface 1114 located in the limiting groove 1112 and opposite to the limiting surface 1113. A distribution direction of the inner side surface 1114 and the limiting surface 1113 forms an angle with the extension direction of the rotation axis X. A mounting hole 1115 is provided on the inner side surface 1114 of the limiting groove 1112. The limiting rod 131 of the limiting mechanism 13 is slidably installed in the mounting hole 1115, and one end of the limiting rod 131 is arranged opposite to the limiting surface 1113.

Therefore, the second driving member 132 drives the limiting rod 131 to slide in the mounting hole 1115, so that one end of the limiting rod 131 can be brought into abutting against or separating from the limiting surface 1113. Moreover, the coils of the optical fiber 40 are limited in the limiting groove 1112, thereby further improving the limiting effect on the coils of the optical fiber 40.

Specifically, the mounting hole 1115 extends to one side of the first clamping member 111 along a direction from the limiting surface 1113 to the inner side surface 1114. The second driving member 132 is provided on one side of the first clamping member 111 along the direction from the limiting surface 1113 to the inner side surface 1114. The second driving member 132 is connected to another end of the limiting rod 131 to drive the limiting rod 131 to slide in the mounting hole 1115 along the distribution direction of the inner surface 1114 and the limiting surface 1113. The second driving member 132 may be a cylinder, a hydraulic cylinder, a motor, etc., and is not limited here.

The first clamping member 111 is arranged in a rod shape and extends along the rotation axis X. The first clamping surface 1120 is located at one end of the first clamping member 111, and the limiting groove 1112 extends between two ends of the first clamping member 111. The limiting groove 1112 penetrates the first clamping member 111 along a first direction. The distribution direction of the inner side surface 1114 and the limiting surface 1113 in the limiting groove 1112 is at an angle with the first direction. The first direction is at an angle with the extension direction of the rotation axis X.

In some embodiments, as illustrated in FIG. 3, the second clamping member 116 includes an elastic pad 117, and the second clamping surface 1171 is formed on the elastic pad 117. As a result, the second clamping member 116 abuts against the optical fiber 40 through the elastic pad 117 to clamp the optical fiber 40. Due to elasticity of the elastic pad 117, the second clamping member 116 can be prevented from exerting an excessive clamping force on the optical fiber 40 and thereby damaging the optical fiber 40. A material of the elastic pad 117 may be rubber, silicone, sponge, etc., and is not limited here.

In some embodiments, as illustrated in FIG. 2 and FIG. 3, the first clamping member 111 includes a first magnetic part 115, the second clamping member 116 includes a second magnetic part 1161, and the first magnetic part 115 is configured to be magnetically attracted to the second magnetic part 116. Therefore, the first magnetic part 115 and the second magnetic part 1161 are magnetically attracted to each other, so that the clamping forces of the first clamping surface 1120 of the first clamping member 111 and of the second clamping surface 1171 of the second clamping member 116 on the optical fiber 40 are improved, thereby improving the clamping and fixing effect of the optical fiber fixing device 10 on the optical fiber 40.

The first clamping surface 1120 is provided with a recess 1126, and the first magnetic part 115 is installed in the recess 1126. Specifically, the first clamping surface 1120 of the positioning member 112 is provided with the recess 1126, and the first magnetic part 115 is provided in the recess 1126 of the positioning member 112.

In some embodiments, as illustrated in FIG. 2, the moving mechanism 14 includes a moving seat 141, a third driving member 142, a rack 143, and a gear 144. The first clamping member 111 is rotatably installed on the moving seat 141. The gear 144 is connected to the first clamping member 111. The rack 143 is meshed with the gear 144. The third driving member 142 is provided on the moving seat 141. The third driving member 142 is connected with the rack 143 and drives the rack 143 to move, so as to drive the first clamping member 111 to rotate through the gear 144, thereby driving the optical fiber 40 to rotate around the rotation axis X.

Specifically, the gear 144 is located at an end of the first clamping member 111 away from the first clamping surface 1120. A central axis of the gear 144 coincides with the rotation axis X. The third driving member 142 may be a motor, a pneumatic cylinder, a hydraulic cylinder, etc., and is not limited here.

In some embodiments, the optical fiber fixing device 10 further includes an angle detection assembly (not shown in the figures). The angle detection assembly is configured to detect a rotation angle of the first clamping member 111. Specifically, the third driving member 142 includes a cylinder, and the angle detection assembly includes a first sensor and a second sensor. After the rack 143 is driven by the cylinder to extend out of a preset length, the first sensor is triggered to determine that the cylinder drives the first clamping member 111 to rotate to a first angle through the rack 143 and the gear 144. After the rack 143 is driven by the cylinder to retract to a preset distance, the second sensor is triggered to determine that the cylinder drives the first clamping member 111 to rotate to a second angle through the rack 143 and the gear 144.

As illustrated in FIG. 2, the moving mechanism 14 further includes a mounting seat 145 and a fourth driving member 146. The moving seat 141 is slidably connected to the mounting seat 145 along the extension direction of the rotation axis X. The fourth driving member 146 is connected to the mounting seat 145 to drive the mounting seat 145 to slide, thereby driving the optical fiber 40 to move along the rotation axis X.

In some embodiments, the optical fiber fixing device 10 further includes a first displacement detection assembly (not shown in the figures), and the first displacement detection assembly is configured to detect a displacement of the mounting seat 145. Specifically, the displacement detection assembly includes a third sensor and a fourth sensor. In a direction from an end of the first clamping member 111 connected with the gear 144 to an end of the first clamping member 111 provided with the first clamping surface 1120, after the fourth driving member 146 drives the mounting seat 145 to slide a preset distance, the third sensor is triggered. In a direction from the end of the first clamping member 111 provided with the first clamping surface 1120 to the end of the first clamping member 111 connected with the gear 144, after the fourth driving member 146 drives the mounting seat 145 to slide a preset distance, the fourth sensor is triggered.

Similarly, the optical fiber fixing device 10 further includes a second displacement detection assembly (not shown in the figures), and the second displacement detection assembly is configured to detect a displacement of the limiting rod 131. The way in which the second displacement detection assembly detects the displacement of the limit rod 131 can refer to the way in which the first displacement detection assembly detects the displacement of the mounting seat 145, which will not be described again here.

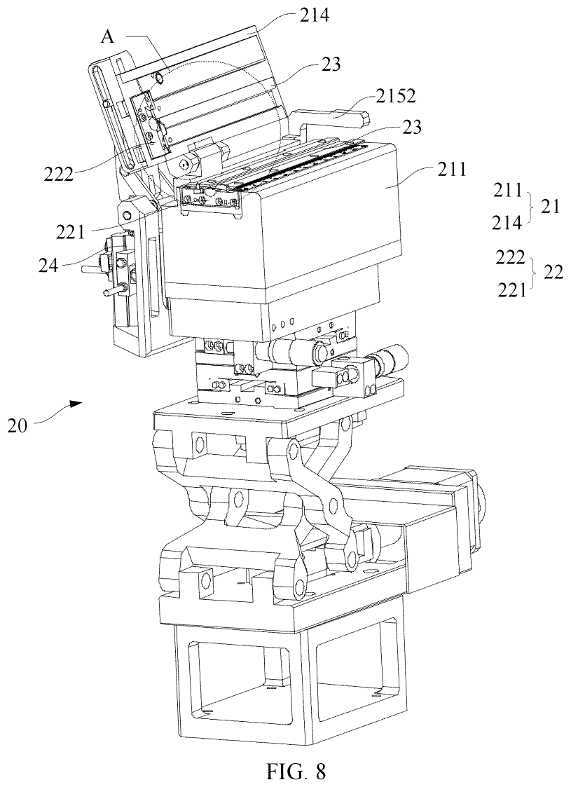

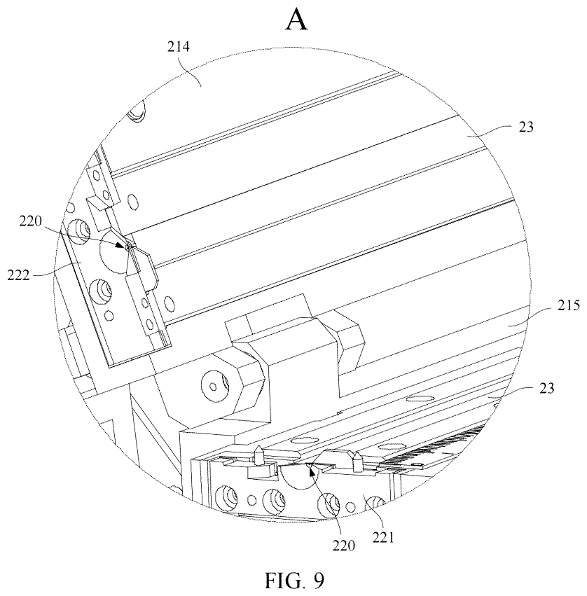

In some embodiments, as illustrated in FIG. 8 to FIG. 11, the stripping device 20 includes a mounting mechanism 21, a cutting mechanism 22, and a heating component 23. The mounting mechanism 21 includes a supporting seat 211 and a mounting cover 214. The mounting cover 214 is slidably connected with the supporting seat 211 and has a clamping position and a releasing position. The supporting seat 211 and/or the mounting cover 214 are provided with the heating component 23, and the heating component 23 is configured to heat the optical fiber 40. The cutting mechanism 22 includes a first blade 221 provided on the supporting seat 211 and a second blade 222 provided on the mounting cover 214.

The mounting cover 214 is arranged opposite to the supporting seat 211 both in the clamping position and in the releasing position. When the mounting cover 214 is in the clamping position, a cutting port 220 is formed between the first blade 221 and the second blade 222 for cutting the coating layer of the optical fiber 40. A distance between the first blade 221 and the second blade 222 when the mounting cover 214 is in the releasing position is greater than a distance between the first blade 221 and the second blade 222 when the mounting cover 214 is in the clamping position.

Therefore, when stripping off the coating layer of the optical fiber 40, the mounting cover 214 can be moved to the releasing position first, so that there is a space for placing the optical fiber 40 between the first blade 221 and the second blade 222. Then the optical fiber 40 is placed between the first blade 221 and the second blade 222, and the mounting cover 214 is moved to the clamping position, so that the optical fiber 40 is positioned in the cutting port 220 formed between the first blade 221 and the second blade 222, and the first blade 221 and the second blade 222 have cut into the coating layer of the optical fiber 40 at this time. At the same time, the optical fiber 40 is heated by the heating component 23 so that the coating layer of the optical fiber 40 can be stripped off more easily. At last, the optical fiber fixing device 10 drives the optical fiber 40 to move relative to the cutting mechanism 22 along the extension direction of the rotation axis X, so that a heated part of the optical fiber 40 passes through the cutting port 220 between the first blade 221 and the second blade 222, and the heated coating layer of the optical fiber 40 is stripped off by the first blade 221 and the second blade 222. The operation is very convenient, and the coating layer of the optical fiber 40 is stripped more efficiently.

Furthermore, by slidably connecting the mounting cover 214 to the supporting seat 211, the first blade 221 installed on the mounting cover 214 and the second blade 222 installed on the supporting seat 211 move in a straight line relative to each other, and a travel between the first blade 221 and the second blade 222 is shorter, so that the first blade 221 and the second blade 222 can cut into the coating layer of the optical fiber 40 more quickly and accurately.

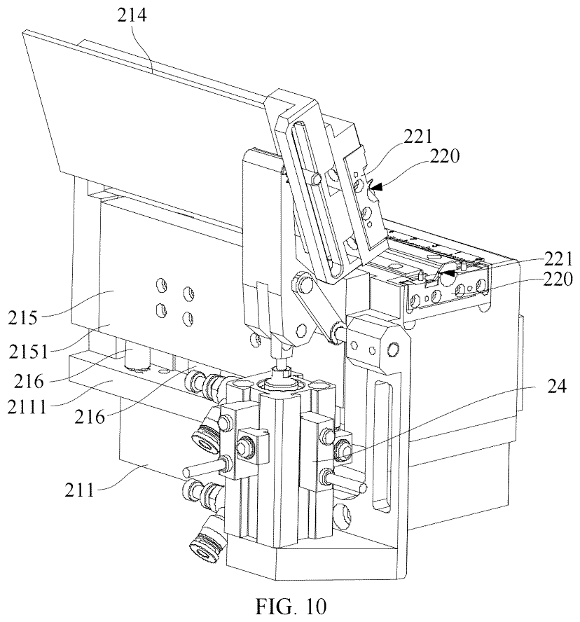

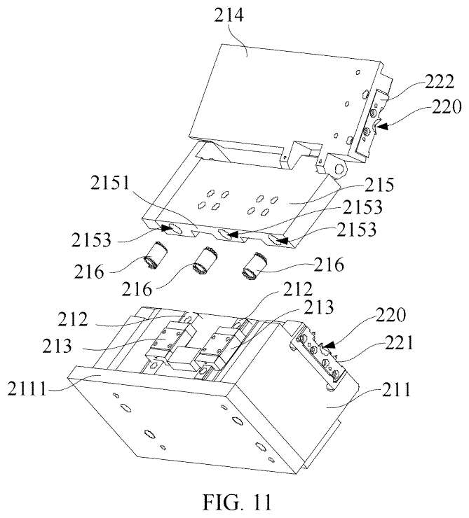

In some embodiments, as illustrated in FIG. 10 and FIG. 11, the mounting mechanism 21 includes a sliding seat 215 slidably connected to the supporting seat 211. The mounting cover 214 is provided on the sliding seat 215 so that the mounting cover 214 is slidably connected to the supporting seat 211. Specifically, a rail 212 extending along a height direction of the supporting seat 211 is provided on one side of the supporting seat 211. The rail 212 is slidably connected to a slider 213. The sliding seat 215 is located on one side of the supporting seat 211 and connected to the slider 213, so that the sliding seat 215 and the supporting seat 211 are slidably connected.

The mounting mechanism 21 further includes an elastic member 216. One end of the elastic member 216 is connected to the supporting seat 211, and another end of the elastic member 216 is connected to the sliding seat 215 to exert an elastic force on the sliding seat 215, so that the sliding seat 215 drives the mounting cover 214 to slide in a direction from the clamping position to the releasing position.

Therefore, in an initial state, the mounting cover 214 is in the releasing position under an action of the elastic member 216. After the optical fiber 40 is placed between the first blade 221 and the second blade 222, a pressure can be applied to the mounting cover 214 to drive the mounting cover 214 to slide from the releasing position to the clamping position, so that the optical fiber 40 is positioned in the cutting port 220 formed between the first blade 221 and the second blade 222, which is very convenient to operate.

In some embodiments, as illustrated in FIG. 1, the stripping apparatus for the coating layer of the optical fiber 1 further includes a pushing mechanism 25. The pushing mechanism 25 is configured to abut against the mounting cover 214 and push the mounting cover 214 to slide along the direction from the releasing position to the clamping position, so that the mounting cover 214 slides to the clamping position. The pushing mechanism 25 may be a pneumatic cylinder, a hydraulic cylinder, or any other mechanism that can push the mounting cover 214 to slide in the direction from the releasing position to the clamping position, and is not limited here.

In some embodiments, as illustrated in FIG. 10 and FIG. 11, the supporting seat 211 includes a first abutting part 2111, the sliding seat 215 includes a second abutting part 2151, and the first abutting part 2111 and the second abutting part 2151 are distributed in sequence along a sliding direction of the sliding seat 215. The elastic member 216 is located between the first abutting part 2111 and the second abutting part 2151. One end of the elastic member 216 is in abutting against the first abutting part 2111, and another end of the elastic member 216 is in abutting against the second abutting part 2151 and applies an elastic force to the second abutting part 2151. A positioning hole 2153 is provided on one side of the second abutting part 2151 facing the first abutting part 2111. Another end of the elastic member 216 is inserted into the positioning hole 2153 and abuts against an inner surface of the positioning hole 2153, so that the elastic member 216 is in more stable abutting against the second abutting part 2151.

In some embodiments, the mounting cover 214 is rotationally connected to the sliding seat 215. The mounting cover 214 can rotate relative to the sliding seat 215 between an open position and the releasing position. A distance between the first blade 221 and the second blade 222 when the mounting cover 214 is in the open position is greater than the distance between the first blade 221 and the second blade 222 when the mounting cover 214 is in the releasing position. Therefore, by placing the mounting cover 214 in the open position, the distance between the first blade 221 and the second blade 222 can be further increased to facilitate placing the optical fiber 40 between the first blade 221 and the second blade 222.

The sliding seat 215 includes a limiting part 2152. When the mounting cover 214 is in the releasing position, the limiting part 2152 is located below the mounting cover 214 and abuts against the mounting cover 214, so that the mounting cover 214 remains stable relative to the sliding seat 215 when in the releasing position.

In addition, the stripping device 20 further includes a driving structure 24 provided on the supporting seat 211. The driving structure 24 is connected to the mounting cover 214 to drive the mounting cover 214 to rotate between the open position and the releasing position. Therefore, the mounting cover 214 can be driven to automatically rotate between the open position and the releasing position through the driving structure 24, making the operation more convenient. The driving structure 24 may be a cylinder, a hydraulic cylinder, a motor, etc., and is not limited here.

As illustrated in FIG. 1 and FIG. 5 to FIG. 7, the cleaning device 30 includes two supply assemblies 31. The supply assembly 31 includes a first driving mechanism 311 and a supply mechanism 312 for supplying a cleaning belt 53. The two supply mechanisms 312 are arranged opposite to each other along the first direction. The cleaning space 301 is formed between the two supply mechanisms 312. A part of the cleaning belt 53 supplied by the supply mechanism 312 is located on one side of the supply mechanism 312 facing the cleaning space 301. The first driving mechanism 311 is connected to the supply mechanism 312 to drive the supply mechanism 312 to move in the first direction. The first direction forms an angle with the extension direction of the rotation axis X. By driving the supply mechanisms 312 to move in the first direction by the first driving mechanisms 311 of the two supply assemblies 31, the cleaning belts 53 of the two supply mechanisms 312 on the sides facing the cleaning space 301 can be moved toward or away from each other. After the optical fiber 40 passes through the cleaning space 301 along the rotation axis X, and after the supply mechanisms 312 are driven by the first driving mechanisms 311 of the two supply assemblies 31 to move toward the cleaning space 301, the two cleaning belts 53 on sides of the two supply mechanisms 312 facing the cleaning space 301 abut against opposite sides of the optical fiber 40, and then, by moving the optical fiber 40 along the rotation axis X, the two cleaning belts 53 can clean the optical fiber 40.

The cleaning device 30 further includes a clamping assembly 32, and the clamping assembly 32 is configured to clamp the cleaning belts 53 located on the sides of the two supply mechanisms 312 facing the cleaning space 301. By clamping the two cleaning belts 53 through the clamping assembly 32, the abutting force between the two cleaning belts 53 and the optical fiber 40 can be improved, so that the two cleaning belts 53 can more fully wrap the optical fiber 40, so as to further improve the cleaning effect of the optical fiber 40.

In some embodiments, as illustrated in FIG. 7, the supply mechanism 312 includes a supporting structure 3121, two mounting shafts 3122 rotatably installed on the supporting structure 3121, a second driving mechanism 3123, and an abutting structure 3124. One of the mounting shafts 3122 is configured to install a first reel 51 wound with the cleaning belt 53, another one of the mounting shafts 3122 is configured to install a second reel 52, and the second reel 52 is configured to connect with one end of the cleaning belt 53. The second driving mechanism 3123 is connected to at least one of the two mounting shafts 3122 and drives the corresponding mounting shaft 3122 to rotate, so that the first reel 51 releases the cleaning belt 53 and the second reel 52 winds the cleaning belt 53.

The second driving mechanism 3123 drives at least one of the two mounting shafts 3122 to rotate, so that the first reel 51 releases the cleaning belt 53, and the second reel 52 winds the cleaning belt 53, thereby a used part of the cleaning belt 53 located in the cleaning space 301 is replaced with a new unused part of the cleaning belt 53, and the used part of the cleaning belt 53 is wound up on the second reel 52.

It should be noted that the second driving mechanism 3123 may be connected to the two mounting shafts 3122 at the same time and drive the two mounting shafts 3122 to rotate, so as to drive the first reel 51 and the second reel 52 to rotate at the same time, thereby the first reel 51 releases the cleaning belt 53, and the second reel 52 winds the cleaning belt 53. Alternatively, the second driving mechanism 3123 may also be connected only to the mounting shaft 3122 for installing the second reel and drive the mounting shaft 3122 to rotate, so as to drive the second reel 52 to rotate, so that the second reel 52 winds the used belt, and the new unused cleaning belt 53 is pulled out from the first reel 51.

Continuing to refer to FIG. 7, the abutting structure 3124 includes two abutting rods 3125 arranged side by side and at intervals on the supporting structure 3121. The cleaning space 301 is formed between the two abutting rods 3125 of each of the two supply mechanisms 312. Sides of the two abutting rods 3125 close to the cleaning space 301 are configured to respectively abut against the cleaning belt 53 between the first reel 51 and the second reel 52. The clamping assembly 32 is configured to clamp the cleaning belts 53 between the two abutting rods 3125 of each of the two supply mechanisms 312.

The supply mechanism 312 abuts against the cleaning belt 53 through sides of the two abutting rods 3125 close to the cleaning space 301, so as to position the cleaning belt 53 in the cleaning space 301, so that the cleaning belt 53 can be more stably in abutting against the optical fibers 40 in the cleaning space 301. Moreover, a space for the clamping assembly 32 to clamp the cleaning belts 53 can be formed between the two abutting rods 3125 of the supply mechanisms 312.

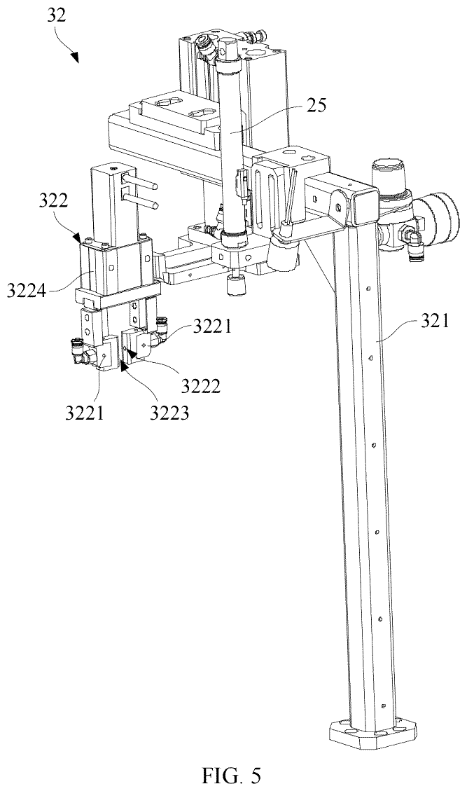

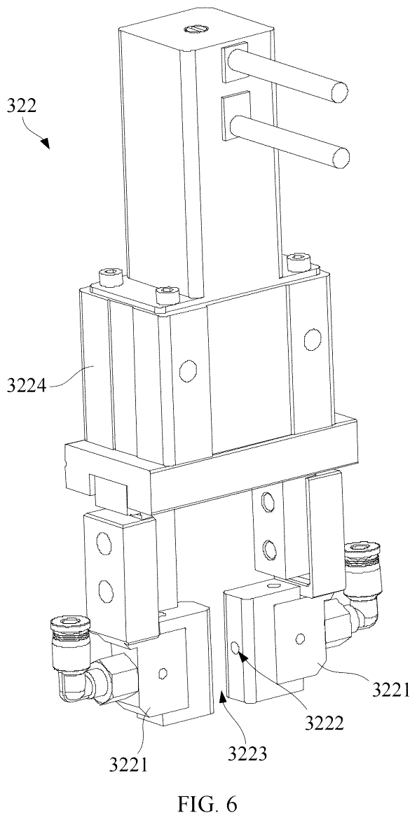

In some embodiments, as illustrated in FIG. 5 and FIG. 6, the clamping assembly 32 includes a bracket 321 and a clamping structure 322. The clamping structure 322 includes two clamping components 3221 and a driving component 3224 connected to the bracket 321. The driving component 3224 is connected to the two clamping components 3221 to drive the two clamping components 3221 toward or away from each other. Therefore, by driving the two clamping components 3221 close to each other through the driving component 3224, the two clamping components 3221 can clamp the two cleaning belts 53 to increase the clamping force between the cleaning belts 53 and the optical fiber 40. When the driving component 3224 drives the two clamping components 3221 away from each other, the second driving mechanism 3123 can easily drive the mounting shaft 3122 to rotate to drive the cleaning belt 53 to move, thereby replacing the cleaning belt 53 in the cleaning space 301.

A clamping space 3223 for clamping the cleaning belt 53 is formed between the two clamping components 3221. At least one clamping component 3221 is provided with a channel 3222. The channel 3222 is configured to communicate with a cleaning agent supply assembly 33. The channel 3222 is provided with a cleaning agent supply port on one side of the corresponding clamping component 3221 facing the clamping space 3223. Therefore, the cleaning agent can be supplied to the cleaning belt 53 through the cleaning agent supply port, so as to improve the cleaning effect of the cleaning belt 53 on the optical fiber 40.

In some embodiments, the cleaning agent may be an organic solvent such as acetone or alcohol.

As illustrated in FIG. 1, the stripping apparatus for the coating layer of the optical fiber 1 includes the cleaning agent supply assembly 33. The cleaning agent supply assembly 33 includes a liquid supply pump and a connecting pipeline (not shown in the figures). The liquid supply pump is communicated with the channel 3222 through the connecting pipeline, so as to supply the cleaning agent to the channel 3222.

In the above embodiments, different aspects were emphasized in the description for each of the embodiments. For parts that are not described in detail in a certain embodiment, please refer to the relevant descriptions for other embodiments.

The stripping apparatus for the coating layer of the optical fiber provided by the embodiments of the present disclosure has been introduced in detail above. Specific examples are used in the context to illustrate the principles and implementation methods of the present disclosure. The description of the above embodiments is only provided to help understanding the technical solutions and core ideas of the present disclosure. Those of ordinary skill in the art should understand that they can still modify the technical solutions recorded in the foregoing embodiments, or make equivalent substitutions for some of the technical features; and these modifications or substitutions do not make the substantial concept of the corresponding technical solutions deviate from the scope of the technical solutions of the embodiments of the present disclosure.

1. A stripping apparatus for a coating layer of an optical fiber, comprising:
an optical fiber fixing device configured to fix the optical fiber and drive the optical fiber to rotate around a rotation axis and move along an extension direction of the rotation axis;
a stripping device provided on one side of the optical fiber fixing device along the extension direction of the rotation axis and configured to strip off the coating layer of the optical fiber; and
a cleaning device comprising a cleaning space for cleaning the optical fiber, wherein the cleaning space is located between the stripping device and the optical fiber fixing device.

2. The stripping apparatus for the coating layer of the optical fiber of claim 1, wherein the optical fiber fixing device comprises a clamping mechanism and a moving mechanism, the clamping mechanism comprises a first clamping member, a second clamping member, and a first driving member, the first clamping member comprises a first clamping surface, the first clamping surface is provided with a guiding groove extending along the rotation axis, the second clamping member comprises a second clamping surface, the first driving member is disposed on the first clamping member, and the first driving member is connected to the second clamping member and configured to drive the second clamping surface close to or away from the first clamping surface; and
the moving mechanism is connected to the first clamping member and configured to drive the first clamping member to rotate around the rotation axis and move along the extension direction of the rotation axis.

3. The stripping apparatus for the coating layer of the optical fiber of claim 2, wherein an inner surface of the guiding groove is provided with one or more through holes configured to communicate with a suction component.

4. The stripping apparatus for the coating layer of the optical fiber of claim 3, wherein a plurality of through holes are provided on the inner surface of the guiding groove, and the plurality of through holes are sequentially distributed along a length direction of the guiding groove.

5. The stripping apparatus for the coating layer of the optical fiber of claim 2, wherein the optical fiber fixing device further comprises a pressure sensor, and the pressure sensor is configured to detect an air pressure in the through hole.

6. The stripping apparatus for the coating layer of the optical fiber of claim 2, wherein the optical fiber fixing device further comprises a limiting mechanism, the limiting mechanism is connected to the first clamping member, and the limiting mechanism is configured to limit coils of the optical fiber to the first clamping member.

7. The stripping apparatus for the coating layer of the optical fiber of claim 6, wherein the limiting mechanism comprises a limiting rod and a second driving member, the first clamping member comprises a limiting surface, the second driving member is provided on the first clamping member, and the second driving member is connected to the limiting rod and drives one end of the limiting rod close to or away from the limiting surface to make the one end of the limiting rod to abut against or separate from the limiting surface.

8. The stripping apparatus for the coating layer of the optical fiber of claim 7, wherein a limiting groove is provided on the first clamping member, the limiting surface of the first clamping member is located in the limiting groove, the first clamping member further comprises an inner side surface located in the limiting groove and opposite to the limiting surface, and a distribution direction of the inner side surface and the limiting surface forms an angle with the extension direction of the rotation axis; and
a mounting hole is provided on the inner side surface of the limiting groove, the limiting rod is slidably installed in the mounting hole, and the one end of the limiting rod is arranged opposite to the limiting surface.

9. The stripping apparatus for the coating layer of the optical fiber of claim 8, wherein the mounting hole extends to one side of the first clamping member along a direction from the limiting surface to the inner side surface;
the second driving member is provided on the side of the first clamping member along the direction from the limiting surface to the inner side surface; and the second driving member is connected to another end of the limiting rod to drive the limiting rod to slide in the mounting hole along the distribution direction of the inner side surface and the limiting surface.

10. The stripping apparatus for the coating layer of the optical fiber of claim 2, wherein the second clamping member comprises an elastic pad, and the second clamping surface is formed on the elastic pad.

11. The stripping apparatus for the coating layer of the optical fiber of claim 2, wherein the first clamping member comprises a first magnetic part, the second clamping member comprises a second magnetic part, and the first magnetic part is configured to be magnetically attracted to the second magnetic part.

12. The stripping apparatus for the coating layer of the optical fiber of claim 11, wherein the first clamping surface is provided with a recess, and the first magnetic part is installed in the recess.

13. The stripping apparatus for the coating layer of the optical fiber of claim 1, wherein the stripping device comprises a mounting mechanism, a cutting mechanism, and a heating component, the mounting mechanism comprises a supporting seat and a mounting cover, the mounting cover is slidably connected with the supporting seat and has a clamping position and a releasing position; the supporting seat and/or the mounting cover are provided with the heating component, and the heating component is configured to heat the optical fiber; the cutting mechanism comprises a first blade provided on the supporting seat and a second blade provided on the mounting cover; and
the mounting cover is arranged opposite to the supporting seat when in the clamping position and the releasing position, respectively; when the mounting cover is in the clamping position, a cutting port is formed between the first blade and the second blade for cutting the coating layer of the optical fiber; and a distance between the first blade and the second blade when the mounting cover is in the releasing position is greater than a distance between the first blade and the second blade when the mounting cover is in the clamping position.

14. The stripping apparatus for the coating layer of the optical fiber of claim 13, wherein the mounting mechanism comprises a sliding seat slidably connected to the supporting seat, and the mounting cover is provided on the sliding seat so that the mounting cover is slidably connected to the supporting seat; and
the mounting mechanism further comprises an elastic member, one end of the elastic member is connected to the supporting seat, and another end of the elastic member is connected to the sliding seat to exert an elastic force on the sliding seat, so that the sliding seat drives the mounting cover to slide in a direction from the clamping position to the releasing position.

15. The stripping apparatus for the coating layer of the optical fiber of claim 14, wherein the stripping apparatus for the coating layer of the optical fiber further comprises a pushing mechanism, and the pushing mechanism is configured to abut against the mounting cover and push the mounting cover to slide along a direction from the releasing position to the clamping position.

16. The stripping apparatus for the coating layer of the optical fiber of claim 14, wherein the mounting cover is rotationally connected to the sliding seat, the mounting cover is configured to rotate relative to the sliding seat between an open position and the releasing position, and a distance between the first blade and the second blade when the mounting cover is in the open position is greater than a distance between the first blade and the second blade when the mounting cover is in the releasing position; the sliding seat comprises a limiting part, and when the mounting cover is in the releasing position, the limiting part is located below the mounting cover and abuts against the mounting cover; and
the stripping device further comprises a driving structure provided on the supporting seat, and the driving structure is connected to the mounting cover to drive the mounting cover to rotate between the open position and the releasing position.

17. The stripping apparatus for the coating layer of the optical fiber of claim 1, wherein the cleaning device comprises a clamping assembly and two supply assemblies, each of the supply assemblies comprises a first driving mechanism and a supply mechanism for supplying a cleaning belt, the two supply mechanisms are arranged opposite to each other along a first direction, the cleaning space is formed between the two supply mechanisms, a part of the cleaning belt supplied by the supply mechanism is located on one side of the supply mechanism facing the cleaning space; the first driving mechanism is connected to the supply mechanism to drive the supply mechanism to move in the first direction; and the first direction forms an angle with the extension direction of the rotation axis; and
the clamping assembly is configured to clamp the cleaning belts located on the sides of the two supply mechanisms facing cleaning space.

18. The stripping apparatus for the coating layer of the optical fiber of claim 17, wherein the supply mechanism comprises a supporting structure, two mounting shafts rotatably installed on the supporting structure, a second driving mechanism, and an abutting structure, one of the mounting shafts is configured to install a first reel wound with the cleaning belt, and another one of the mounting shafts is configured to install a second reel, and the second reel is configured to connect with one end of the cleaning belt; the second driving mechanism is connected to at least one of the two mounting shafts and drives the corresponding one of the mounting shafts to rotate, so that the first reel releases the cleaning belt and the second reel winds the cleaning belt; and
the abutting structure comprises two abutting rods arranged side by side and at intervals on the supporting structure, the cleaning space is formed between the two abutting rods of each of the two supply mechanisms, and sides of the two abutting rods close to the cleaning space are configured to respectively abut against the cleaning belt between the first reel and the second reel; and the clamping assembly is configured to clamp the cleaning belts between the two abutting rods of each of the two supply mechanisms.

19. The stripping apparatus for the coating layer of the optical fiber of claim 17, wherein the clamping assembly comprises a bracket and a clamping structure, the clamping structure comprises two clamping components and a driving component connected to the bracket, the driving component is connected to the two clamping components to drive the two clamping components toward or away from each other; and
a clamping space for clamping the cleaning belt is formed between the two clamping components, at least one of the clamping components is provided with a channel, the channel is configured to communicate with cleaning agent supply assembly, and the channel is provided with a cleaning agent supply port on one side of a corresponding one of the clamping components facing the clamping space.

20. The stripping apparatus for the coating layer of the optical fiber of claim 19, wherein the cleaning agent supply assembly comprises a liquid supply pump and a connecting pipeline, and the liquid supply pump is communicated with the channel through the connecting pipeline to supply the cleaning agent to the channel.
